(19) United States
(12) Patent Application Publication
(10) Pub. No.: US 2012/0029830 A1
(43) Pub. Date: Feb. 2, 2012

(54) BLOOD GLUCOSE MEASUREMENT DEVICES AND METHODS OF USING THE SAME

(76) Inventors: Richard W. Turner, Indianapolis, IN (US); Julie K. Turner, Indianapolis, IN (US)

(21) Appl. No.: 13/130,929

(22) PCT Filed: Jul. 27, 2010
(86) PCT No.: PCT/US10/43339

§ 371 Date: May 24, 2011

(51) Int. Cl. G06F 19/00

(52) U.S. Cl. 702/19

(57) ABSTRACT

Blood glucose measurement devices and methods of using the same. In at least one exemplary embodiment of a device of the present disclosure, the device comprises a main housing sized and shaped to receive a lancet assembly and a test strip holder, a circuit board positioned within the main housing, the circuit board capable of producing data indicative of a test strip fluid, and a processor operably coupled to the circuit board, the processor capable of receiving and processing the data from the circuit board and displaying a processed result on a screen.

### PRIORITY

The present application is related to, and claims the priority benefit of, U.S. Provisional Patent Application Ser. No. 61/291,646, filed Dec. 31, 2009, the contents of which are hereby incorporated by reference in their entirety into this disclosure.

### BACKGROUND

There are a myriad of blood glucose test meters for use in performing blood glucose testing. Such meters are operable by providing a blood glucose test strip having a reagent thereon, whereby the reagent reacts with a sample of blood (blood plasma or blood serum) deposited thereon that is then read by the blood glucose meter to ascertain a blood glucose level. Test blood is collected by pricking the body (usually a finger) with a lancet and depositing the resultant drop of blood onto the blood glucose test strip. The blood glucose test strip is then inserted into the blood glucose test meter for analysis.

While such blood glucose test meters are used over and over again, a new blood glucose test strip is required for each test. Thus, the user needs a ready supply of blood glucose test strips. Typically, the supply of blood glucose test strips are sold and stored in a container that is separate from the blood glucose test meter. A desiccant is also typically included in the blood glucose test strip container in order to keep the blood glucose test strips moisture free. Moreover, the lancet is typically also provided separately from the blood glucose testing meter. Thus, in addition to the blood glucose testing meter and the blood glucose test strips, the user must additionally carry a lancet.

It is therefore apparent from the foregoing that the process of blood glucose testing requires the use of several components which the user must carry with them in order to perform the blood glucose testing. It would therefore be desirable to have a compact and simple blood glucose test meter that incorporates a replaceable supply of blood glucose test strips and a replaceable, adjustable depth lancing device that can easily and comfortably fit into a user's pocket, purse or tote.

### BRIEF SUMMARY

The present disclosure provides various meters and kits for testing blood including, but not limited to, testing blood glucose levels.

In an exemplary embodiment of a device of the present disclosure, the device comprises a main housing sized and shaped to receive a lancet assembly and a test strip holder, a circuit board positioned within the main housing, the circuit board capable of producing data indicative of a test strip fluid, and a processor operably coupled to the circuit board, the processor capable of receiving and processing the data from the circuit board and displaying a processed result on a screen. In another embodiment, the device further comprises a lancet assembly positioned at least partially within the main housing, the lancet assembly comprising a lancet and a lancet mechanism. In yet another embodiment, the lancet assembly is removable from the main housing. In an additional embodiment, the lancet assembly comprises a lancet holder sized and shaped to removably engage a lancet. In yet an additional embodiment, the lancet mechanism is operable to cause the lancet to at least partially protrude from the main housing.

In an exemplary embodiment of a device of the present disclosure, the lancet mechanism comprises a button, whereby depression of the button causes the lancet to at least partially protrude from the main housing. In an additional embodiment, when the button is released, the lancet retracts back into the main housing. In yet an additional embodiment, the lancet assembly further comprises a depth mechanism to adjust a penetration depth of the lancet. In another embodiment, the depth mechanism comprises a dial so that the penetration depth of the lancet is a variable penetration depth. In yet another embodiment, the depth mechanism comprises a body having a defined width, wherein when the body is positioned relative to the lancet assembly, the lancet is capable of protruding only a known distance beyond the body. In an additional embodiment, the body comprises a plurality of interchangeable bodies, each of the plurality of interchangeable bodies having various defined widths.

In an exemplary embodiment of a device of the present disclosure, the device further comprises a removable lancet assembly cap, the removable lancet assembly cap sized and shaped to removably enclose the lancet within the lancet assembly. In another embodiment, the device further comprises a test strip holder positioned within the main housing, the test strip holder sized and shaped to receive a plurality of test strips. In yet another embodiment, the test strip holder is removable from the main housing. In an additional embodiment, the main housing further comprises a housing coupling arrangement capable of receiving, retaining, and dispensing the test strip holder. In another embodiment, the housing coupling arrangement comprises a slot sized and shaped to receive a flange of the test strip holder. In yet another embodiment, the housing coupling arrangement comprises a protrusion sized and shaped to engage an indention of the test strip holder.

In an exemplary embodiment of a device of the present disclosure, the device further comprises a first removable test strip holder cap, the first removable test strip holder cap sized and shaped to removably close a cavity defined within the test strip holder to enclose one or more optional test strips within the test strip holder. In another embodiment, the device further comprises a second removable test strip holder cap, the second removable test strip holder cap sized and shaped to removably close a cavity defined within the test strip holder to enclose one or more optional test strips within the test strip holder. In an additional embodiment, the device further comprises a desiccant positioned within the test strip holder, the desiccant capable of reducing a local humidity level within the test strip holder. In an additional embodiment, the device further comprises a used test strip slot defined within the main housing, the used test strip slot sized and shaped to received one or more used test strips for retention within the main housing. In another embodiment, the device further comprises an absorbent pad removably coupled to the main housing, the absorbent pad capable of absorbing blood from a user.

In an exemplary embodiment of a device of the present disclosure, the circuit board comprises a test strip acceptance and reading area, the test strip acceptance and reading area capable of receiving at least part of a test strip and producing the data indicative of a test strip fluid from the test strip. In another embodiment, the device further comprises a display operably coupled to the processor, the display capable of displaying the processed result from the processor. In yet another embodiment, the display comprises a liquid crystal display. In an additional embodiment, the device further comprises a user controller operably coupled to the processor, the user controller capable of selecting between two or more processor operations. In yet an additional embodiment, the user controller comprises one or more buttons.

In an exemplary embodiment of a device of the present disclosure, the device further comprises a memory device operably coupled to the processor, the memory device capable of receiving and storing data from the circuit board. In an additional embodiment, the memory is further capable of receiving and storing software accessible by the processor for operating the device. In yet an additional embodiment, the device further comprises a power source operably coupled to the processor, the power source capable of supplying power to operate the device. In another embodiment, the power source comprises a battery. In yet another embodiment, the battery is rechargeable. In even another embodiment, the battery is removable from the device.

In an exemplary embodiment of a device of the present disclosure, the device further comprises a data transfer mechanism operably coupled to the processor or a memory coupled thereto, the data transfer mechanism capable of transferring the data from the device to an external computer. In another embodiment, the data transfer mechanism is further capable of transferring software to or from the device. In yet another embodiment, the data transfer mechanism comprises a USB port. In an additional embodiment, the data transfer mechanism comprises a wireless communications apparatus. In yet an additional embodiment, the main housing is sized and shaped to fit within a garment pocket.

In an exemplary embodiment of a device of the present disclosure, the device comprises a main housing, a test strip holder removably positioned at least partially within the main housing, the test strip holder capable of receiving at least one test strip, a lancet assembly removably positioned at least partially within the main housing, the lancet assembly capable of receiving a lancet, a circuit board positioned within the main housing, the circuit board comprising a test strip acceptance and reading area capable of receiving at least part of a test strip and producing the data indicative of a test strip fluid from the test strip, a processor operably coupled to the circuit board, the processor capable of receiving and processing the data from the circuit board, and a display operably coupled to the processor, the display capable of displaying the processed result from the processor.

In an exemplary embodiment of a device of the present disclosure, the device comprises a main housing sized and shaped to receive a lancet assembly and a test strip holder, a lancet assembly positioned at least partially within the main housing, the lancet assembly comprising a lancet, a lancet mechanism operable to cause the lancet to at least partially protrude from the main housing, and a depth mechanism to adjust a penetration depth of the lancet, a test strip holder positioned within the main housing, the test strip holder sized and shaped to receive a plurality of test strips, a used test strip slot defined within the main housing, the used test strip slot sized and shaped to received one or more used test strips for retention within the main housing, an absorbent pad removably coupled to the main housing, the absorbent pad capable of absorbing blood from a user, a circuit board positioned within the main housing, the circuit board comprising a test strip acceptance and reading area capable of receiving at least part of a test strip and producing the data indicative of a test strip fluid from the test strip, a processor operably coupled to the circuit board, the processor capable of receiving and processing the data from the circuit board, a memory device operably coupled to the processor, the memory device capable of receiving and storing data from the circuit board, a display operably coupled to the processor, the display capable of displaying the processed result from the processor, and a power source operably coupled to the processor, the power source capable of supplying power to operate the device.

In an exemplary embodiment of a device for testing blood glucose levels of the present disclosure, the device comprises a main housing, a test strip holder removably positioned at least partially within the main housing, the test strip holder capable of receiving at least one glucose test strip, a lancet assembly removably positioned at least partially within the main housing, the lancet assembly capable of receiving a lancet, a circuit board positioned within the main housing, the circuit board capable of producing data indicative of blood from a used test strip, a processor operably coupled to the circuit board, the processor capable of receiving and processing the data from the circuit board, and a display operably coupled to the processor, the display capable of displaying a processed blood glucose level result indicative of the data on a screen.

In an exemplary embodiment of a method for testing a blood glucose level of the present disclosure, the method comprising the steps of removing a test strip from a test strip holder of a glucose testing device, inserting at least part of the test strip into a test strip acceptance and reading area of the glucose testing device, positioning the glucose testing device on or near a user's skin, operating a lancet of the glucose testing device to penetrate the user's skin so that a quantity of blood exits a skin puncture caused by the lancet, transferring at least part of the quantity of blood to the test strip, and operating the glucose testing device to obtain data indicative of a blood glucose level from the quantity of blood. In another embodiment, the method further comprises the step of wiping excess blood from the quantity of blood onto an absorbent pad coupled to the glucose testing device. In yet another embodiment, the method further comprises the steps of removing the test strip from the test strip acceptance and reading area, and inserting the test strip into a used test strip slot defined within the glucose testing device to store the test strip within the glucose testing device.

In an exemplary embodiment of a kit of the present disclosure, the kit comprises a device for testing a blood glucose level, a blood glucose test strip assembly sized and shaped to be received within the device, and a lancet sized and shaped to be received within a lancet assembly within the device. In another embodiment, the kit further comprises a tablet comprising a sugar, the tablet sized and shaped to fit within the device.

In an exemplary embodiment of a kit of the present disclosure, the kit comprises a device for testing a blood glucose level, a blood glucose test strip assembly sized and shaped to be received within the device, a test strip packet comprising one or more test strips, the one or more test strips sized and shaped to fit within the blood glucose test strip assembly, and a lancet packet comprising one or more lancets, the one or more lancets sized and shaped to be received within a lancet assembly within the device. In an additional embodiment, the test strip packet comprises a desiccant. In another embodiment, the kit further comprises a tablet packet comprising one or more tablets comprising a sugar, the one or more tablets sized and shaped to fit within the device.

### BRIEF DESCRIPTION OF THE DRAWINGS

The above mentioned meters and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1A shows a front view of an exemplary meter, according to an embodiment of the present disclosure;

FIG. 1B shows a back view of an exemplary meter, according to an embodiment of the present disclosure;

FIGS. 2A and 2B show a front perspective view and a back perspective view, respectively, of an exemplary meter according to an embodiment of the present disclosure;

FIGS. 3A and 3B show perspective views of the inside back and inside front, respectively, of an exemplary meter according to an embodiment of the present disclosure;

FIG. 4A shows a perspective exploded view of an exemplary blood glucose test strip assembly, according to an embodiment of the present disclosure;

FIG. 4B shows a perspective exploded view of an exemplary lancet assembly, according to an embodiment of the present disclosure;

FIG. 5 shows an exploded view of various components of an exemplary meter, according to an embodiment of the present disclosure;

FIG. 6A shows an exemplary kit, according to an embodiment of the present disclosure; and

FIGS. 6B through 6D show various packets for use in connection with an exemplary kit, according to an embodiment of the present disclosure.

Like reference numerals indicate the same or similar parts throughout the several figures.

An overview of the features, functions and/or configuration of the components depicted in the various figures will now be presented. It should be appreciated that not all of the features of the components of the figures are necessarily described. Some of these non discussed features, such as various fasteners, etc., as well as discussed features are inherent from the figures. Other non discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present invention is a blood glucose test/testing meter or monitor for ascertaining blood glucose level from a sample of blood that is the size of a standard credit card and which incorporates a replaceable blood glucose test strip cartridge that holds a plurality of blood glucose test strips and a desiccant, and a replaceable, adjustable depth lancet/lancing assembly. The slim profile of the present blood glucose meter allows easy and discreet storage and carrying thereof. Additionally, since both the blood glucose test strips and the lancing device are on-board with the blood glucose meter, there is no need to carry any other testing supplies.

Referring to the figures, there is depicted and exemplary embodiment of a monitor, meter, unit or device, generally designated as reference 10 (collectively and hereinafter, “meter 10”), with various embodiments fashioned in accordance with the present disclosure. In at least one embodiment of a meter 10 of the present disclosure, meter 10 is a blood glucose meter 10 capable of testing a blood glucose level from a sample of blood.

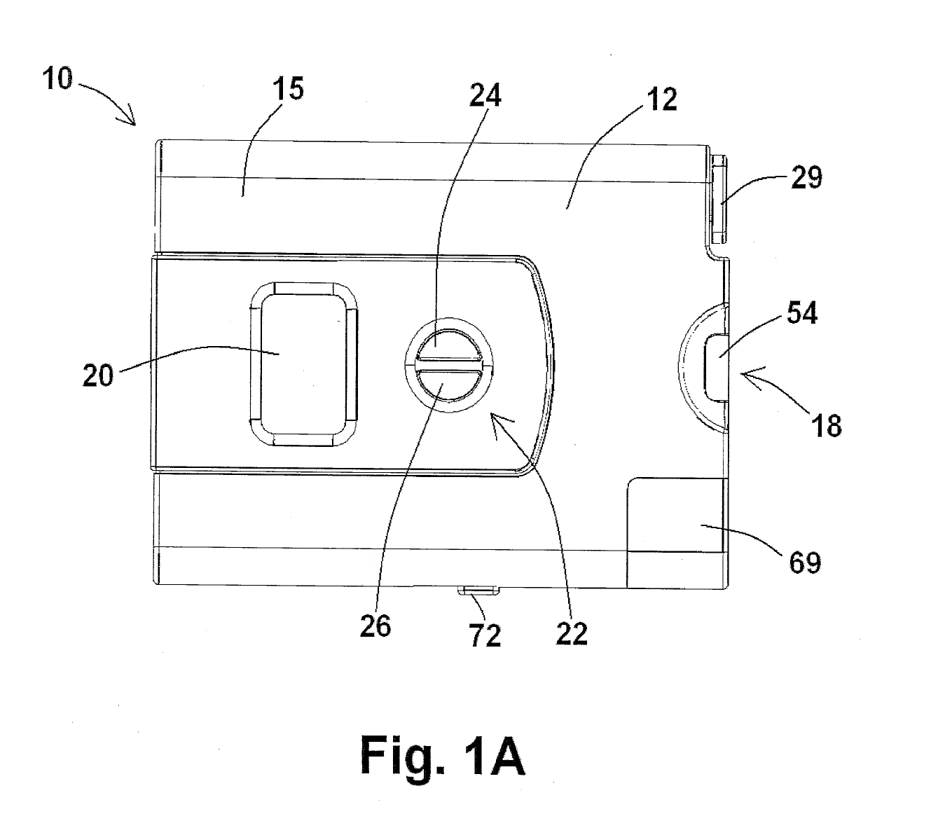

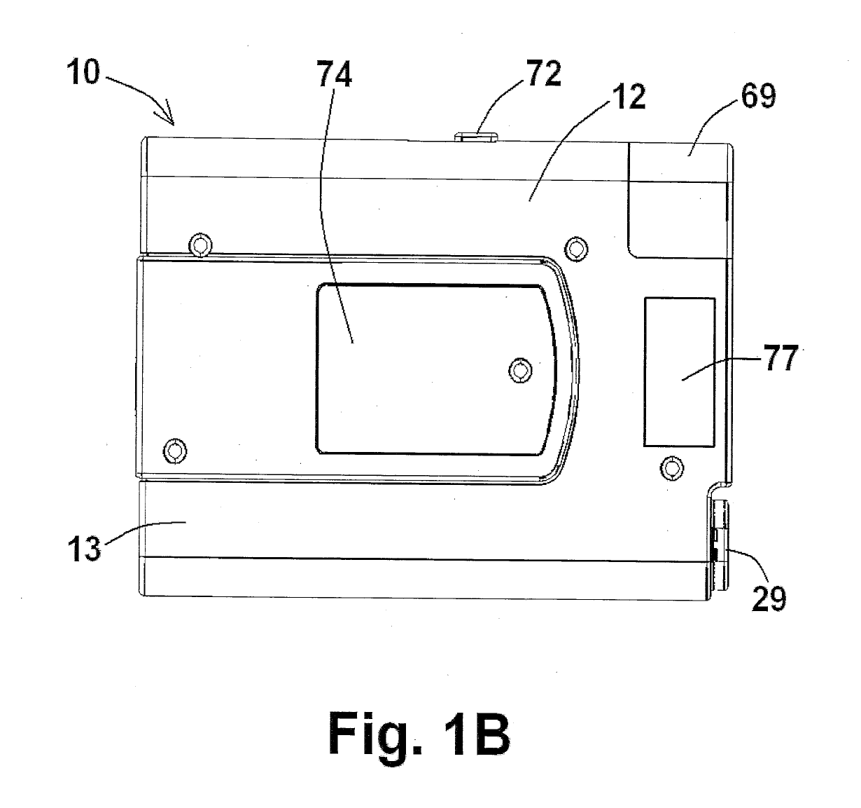

A front view of an exemplary embodiment of a meter 10 of the present disclosure is shown in FIG. 1A. As shown in FIG. 1A, meter 10 is characterized by a housing 12 having in at least one embodiment a rectangular configuration/shape. In an exemplary embodiment, housing 12 has the approximately length and width of a typical credit card with a thickness greater than a typical credit card. In such an embodiment, for example, housing 12 is generally rectangular and has a slim depth. Various embodiments of meters 10 of the present disclosure may have a size and shape allowing meter 10 to easily fit into a pocket, purse, handbag or the like. Moreover, a meter 10 having a rectangular shape, for example, may permit easy holding and manipulation of meter 10.

A rear view of an exemplary embodiment of a meter 10 of the present disclosure is shown in FIG. 1B. As shown in FIG. 1B, and similar to meter 10 shown in FIG. 1A, meter 10 is characterized by a housing 12 having in at least one embodiment a rectangular configuration/shape, and further comprising a number of additional features/components as provided in further detail herein.

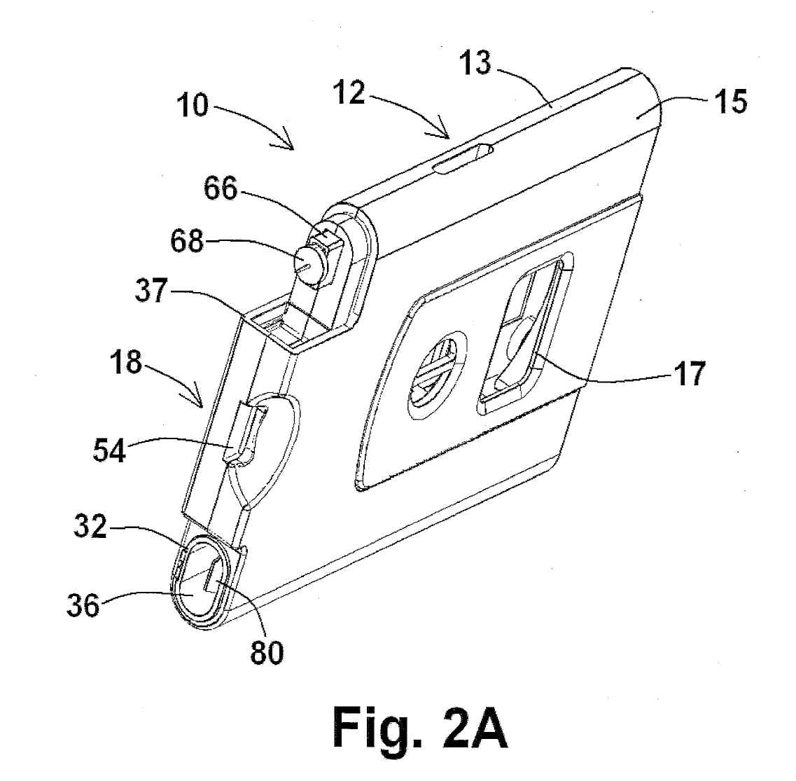

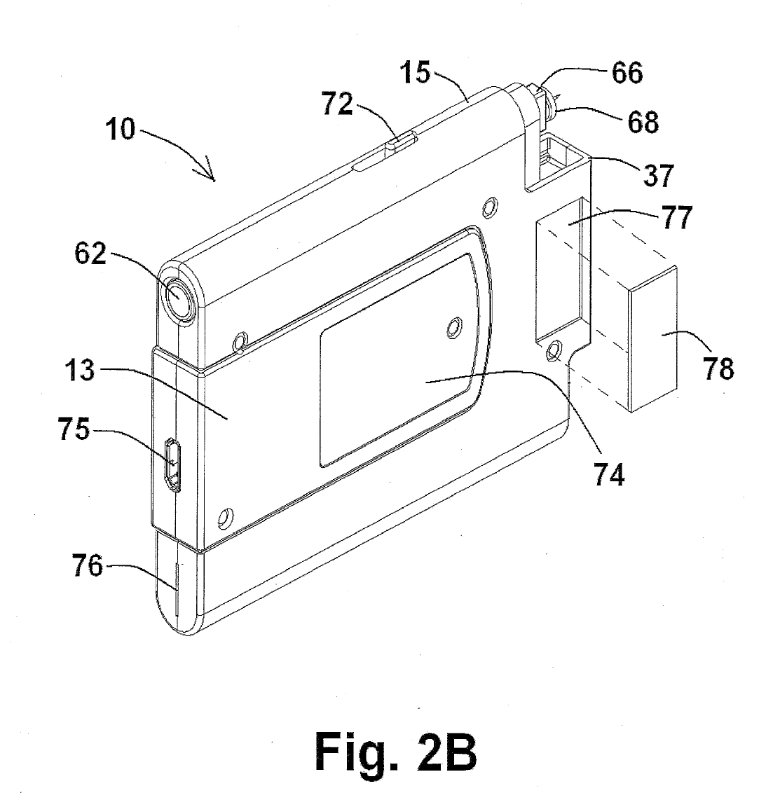

Perspective views of an exemplary embodiment of a meter 10 of the present disclosure are shown in FIGS. 2A and 2B. As shown in FIGS. 2A and 2B, meter 10 comprises an exemplary housing 12 may be formed from a first housing half 13 and a second housing half 15, whereby first and second housing halves 13 and 15 define front and rear sides of meter 10. The first and second housing halves 13, 15 may be formed of plastic and/or any number of other suitable materials.

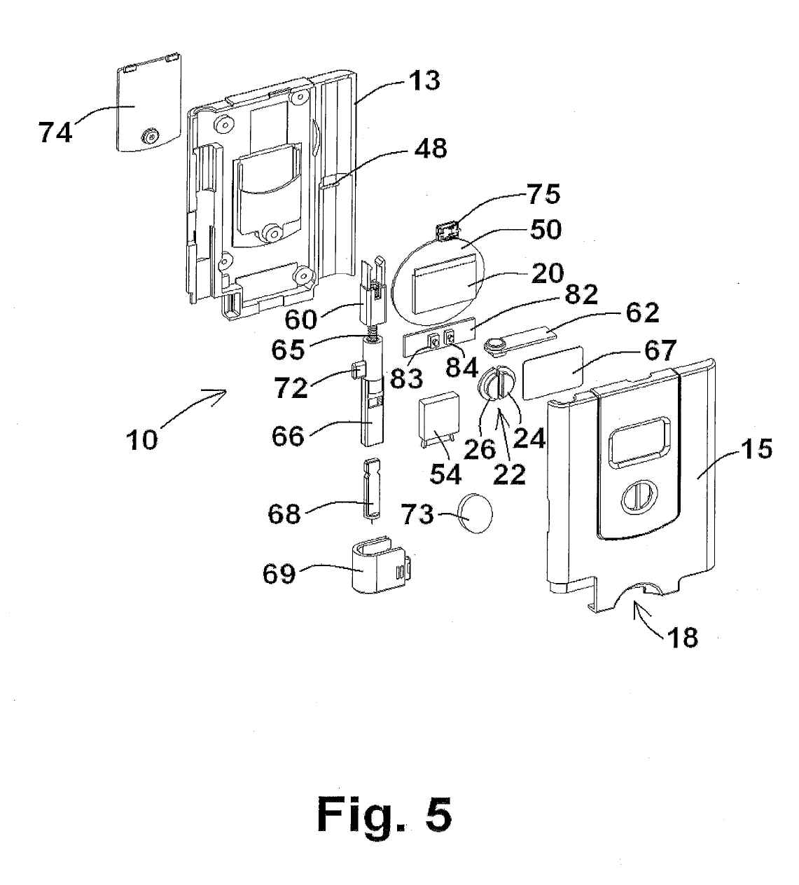

As shown in FIG. 1A, an exemplary meter 10 of the present disclosure comprises a display or screen 20 that is viewable through a cutout 17 in the second housing half 15 (as shown in FIG. 2A, for example). In at least one embodiment, and as shown in FIG. 5, display 20 may be covered using a window 67. Display 20 may be viewable through any number of components of housing 12, including, but not limited to, first and second housing halves 13, 15 of various meter 10 embodiments. Display 20, in at least one embodiment, is lighted and is operable to show various data and/or information obtained and/or processed by various components of meter 10. In at least one embodiment, display 20 may display blood glucose information in connection with tested blood. For instance, and without being exhaustive, various displays 20 of the present disclosure are capable of showing date, time, blood glucose level(s) in either mg/dL or mmol/L, and/or blood glucose level averages in either mg/dL or mmol/L. Various types of displays 20 may be used with exemplary meters 10 of the present disclosure, such as liquid crystal displays (LCDs) or the like.

In order to control what is shown on the display 20, and in at least one embodiment, meter 10 comprises a user controller 22 comprising an first button 24 and a second button 26 as shown in FIG. 1A. In other embodiments, for example, meter 10 may comprise a user controller 22 comprising only a first button 24, or may comprise more buttons than first and second buttons 24, 26. Various information and/or data, as well as operating modes of exemplary meters 10, are selectable by a user via the first and/or lower buttons 24, 26 of user controller 22.

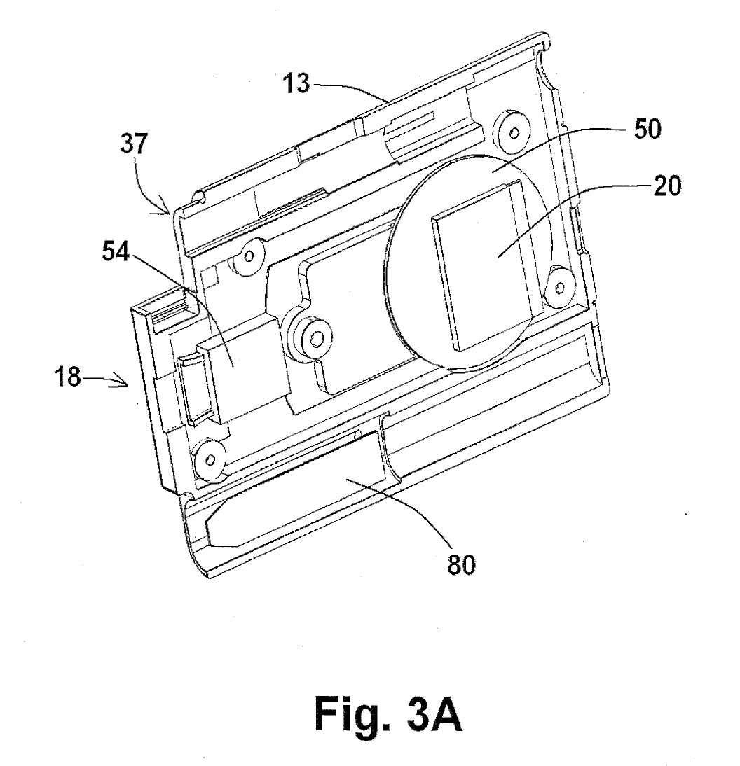

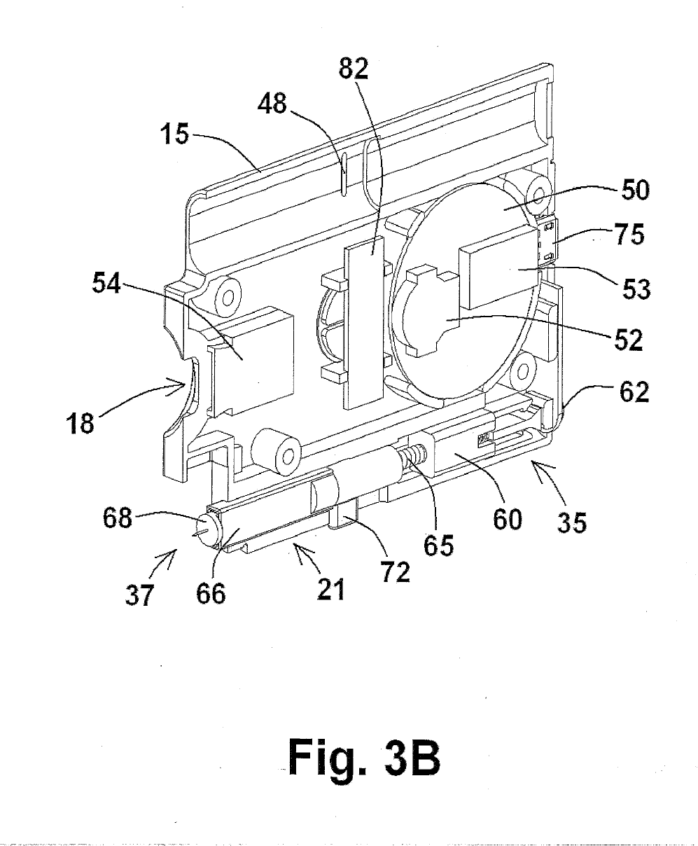

Display 20, in various embodiments, is also part of a circuit board 50 as shown in FIG. 3A. User controller 22 may interface with circuit board 50, or a component of meter 10 in communication with circuit board 50, by way of a PCT tact switch 82 positioned near user controller 22. In such an embodiment, and as shown in FIG. 5, depressing user controller 22 would cause user controller 22 to depress PCT tact switch 82 (and optionally additional tact switches 83, 84 coupled thereto) so that depressing user controller 22 activates meter 10 in some fashion.

An exemplary meter 10 operating as a blood glucose meter 10 of the present disclosure is configured, operable and/or adapted to accept a sample of blood for testing blood glucose level via a test strip 80 as shown in FIG. 2B. As such, the housing 12 (first housing half 13 as shown in FIG. 2B) has a test opening, slot or area (collectively a “test opening” 18) that accepts a test strip 80. Test opening 18 is configured to allow the insertion of at least part of a test strip 80 therein and the retrieval or removal of the used test strip 80 after testing is completed, for example. As such, the test opening 18 is shaped to allow a user's finger to easily grasp the inserted test strip 80.

In order to test a blood sample that has been deposited or received on the inserted test strip 80, meter 10 comprises a blood glucose test strip acceptance and reading area (or test strip processing portion) 54 as shown in FIG. 3A. In at least one embodiment, test strip acceptance and reading area 54 is part of circuit board 50, and in other embodiments, such as the embodiment shown in FIG. 3A, test strip acceptance and reading area 54 is separate from, but operably connected to, of circuit board 50. Test strip acceptance and reading area 54 utilizes known blood glucose testing and reading hardware, processes and methods to obtain a blood glucose level (reading) from the blood sample on test strip 80.

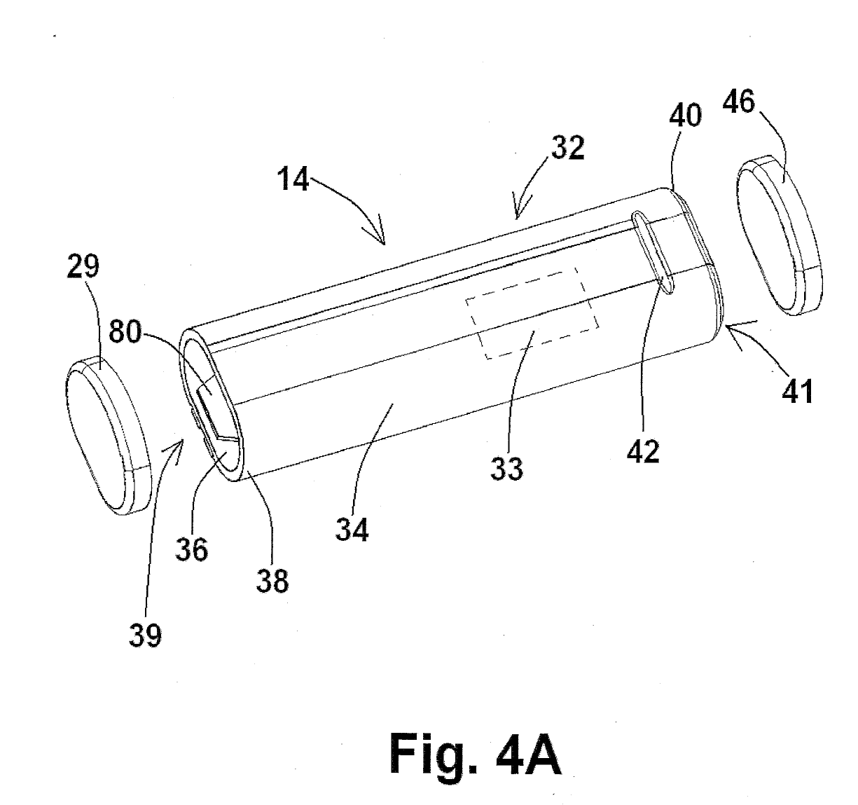

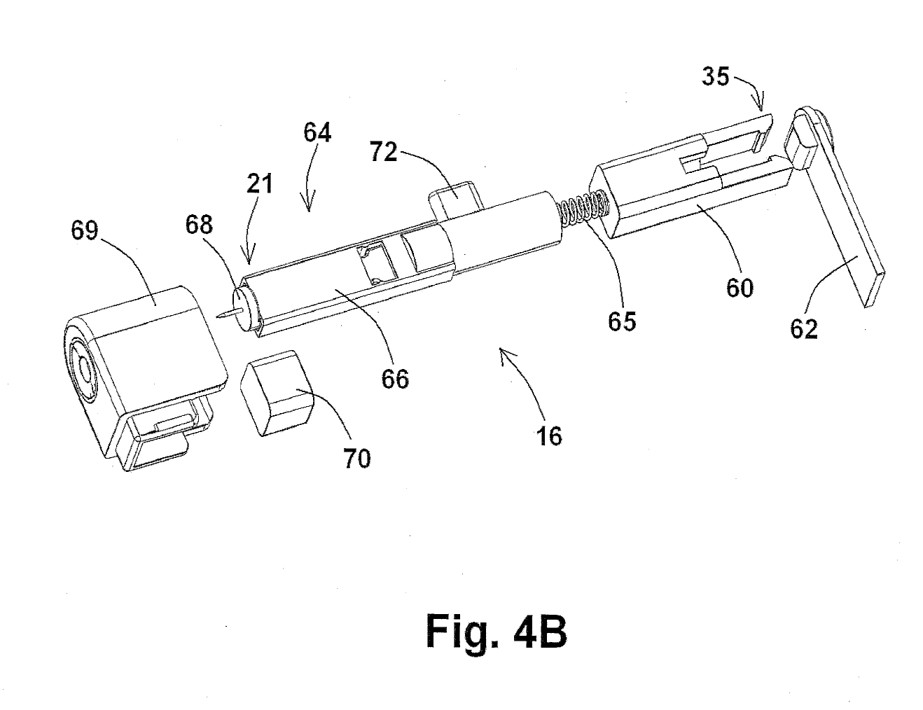

An exemplary blood glucose meter 10 of the present disclosure further comprises an on-board blood glucose test strip holder or assembly 14 that is configured to hold and dispense one or more blood glucose test strips 80. Blood glucose test strip assembly 14, as shown in FIG. 4A and in various other embodiments, may be characterized as a cartridge, magazine or container 32 (collectively a “cartridge” 32) having an elongated body 34 that, in at least one embodiment, is formed of plastic. Cartridge 32, in at least one embodiment, has a cartridge coupling arrangement 42 that allows the cartridge 32 (assembly 14) to be removably and/or permanently coupled to the housing 12 by way of a housing coupling arrangement 48. In at least one exemplary embodiment, cartridge coupling arrangement 42 comprises an indention sized and shaped to be received by a housing coupling arrangement 48. In another exemplary embodiment, cartridge coupling arrangement 42 comprises an elongated flange sized and shaped to be received by a housing coupling arrangement 48 comprising an indention. In this manner, the blood glucose test strip assembly 14 is captured by and between the first and second housing halves 13, 15 of meter 10.

In an exemplary embodiment, and as shown in FIG. 4A, cartridge body 34 has a cavity 36 that extends from a top end 38 to a bottom end 40. Top end 38, in such an embodiment, has an end opening 39 to the cavity 36 and is configured to accept a blood glucose test strip assembly 14. Blood glucose test strip assembly 14, in an exemplary embodiment, includes an end cap 29 that is configured to be accepted by, coupled to, and/or retained on top end 38 to seal/enclose cavity 36. Blood glucose test strip assembly 14 holds one or more blood glucose test strips 80 therein, whereby blood glucose test strips 80 are retained within blood glucose test strip assembly 14 when end cap 29 is positioned thereon.

In at least one embodiment, an internal desiccant 33 may be provided within blood glucose test strip assembly 14. Desiccant 33, which may be within its own packaging or provided separately within blood glucose test strip assembly 14, helps keep the test strips dry and usable during storage thereof by absorbing local moisture. In at least one embodiment, desiccant 33 may be coupled to or part of blood glucose test strip assembly 14.

In various embodiments, bottom end 40 of blood glucose test strip assembly 14 has an end opening 41 to cavity 36 such that one or more blood glucose test strips 80 may be accessed from the cartridge 32. A bottom end cap 46 is provided that is configured to be accepted by, coupled to, and/or retained on the bottom end 40 of cartridge 32 and to seal/enclose cavity 36 when installed. Bottom end cap 46 is removable to allow the user to access and remove a test strip 80 for blood testing. In various embodiments, but not required by any particular embodiment, blood glucose test strip assembly 14 either does not have a bottom end cap 46, or bottom end cap 46 is permanently secured to blood glucose test strip assembly.

In at least one embodiment of the present disclosure, blood glucose test strip assembly 14 is a replaceable assembly such that a user need only remove the spent assembly 14 and replace it with a new assembly 14. In such an embodiment, for example, the new assembly 14 would have one or more new blood glucose test strips 80 and optionally a new desiccant 33. In another embodiment, housing 12 may be configured to allow removal and replacement of the entire blood glucose test strip assembly 14 with a new blood glucose test strip assembly 14 that has a new plurality of blood glucose test strips 30 and a new desiccant 33.

In various embodiments of meter 10 of the present disclosure, meter 10 has an on-board lancet assembly 16. Lancet assembly 16 is retained by housing 12, and in at least one embodiment, by the first housing half 13 the second housing half 15 (the latter as shown in FIG. 3B). Lancet assembly 16, as shown in FIG. 4B and in various other embodiments, includes a spring-loaded holder 60 which provides a support for a replaceable lancet cartridge 64. Lancet cartridge 64 includes a lancet, lancing device, needle or the like (collectively a “lancet” 68) that is retained in a lancet holder 66. As referenced herein, a “lancet mechanism” may comprise one or more of a spring-loaded holder, a button 62, a lancet cartridge 64, a spring 65, a lancet holder 66, and a dial 69, as provided in further detail below.

In at least one embodiment, and as shown in FIG. 4B, an optional depth mechanism 70 is provided that is coupled to and adjusts or sets the depth that the lancet 68 protrudes from housing 12 (for example, protrusion from the first and second end portions 35 and 21, forming a lancet end 37, of the first and second housing halves 13, 15 respectively) such that depth mechanism 70 provides a variable penetration depth for the lancet 68. In at least one embodiment, depth mechanism 70 comprises a dial 70 that when adjusted by a user causes a penetration depth of lancet 68 to vary. In at least another embodiment, depth mechanism 70 comprises a body having a defined width, wherein when the body is positioned relative to lancet 68 (or lancet assembly 16), lancet 68 is capable of protruding only a known distance beyond the body.

In an exemplary embodiment, a button 62 is retained by holder 60 and is configured to extend from housing 12 such that depressing button 62 against a spring 65 provides tension bias of holder 60 extends lancet 68 from lancet end 37 of the housing to a depth as set by dial 70. An actuator 72, as shown in FIG. 4B, may also be used to protract, retract, and/or otherwise move lancet 68 within housing 12. Releasing button 62, in such an embodiment, causes the spring bias of holder 60 to retract lancet 68 back into housing 12. In this fashion, a momentary pricking of a user's finger or other body part is performed to obtain a blood sample that is then deposited onto a test strip 14. In an exemplary embodiment, a removable cap 69 is provided that fits over the lancet end 37 of housing 12, thus protecting lancet 68 and preventing contaminates away from lancet 68. In various embodiments of the present disclosure, lancet holder 66 is removable from housing 12 such that lancet holder 66 may be changed out or replaced as desired. Similarly, lancet 68 may be removed from lancet holder 66 and replaced as desired.

In order to test a sample of blood, and in at least one embodiment of a method of using a meter 10 of the present disclosure, the user obtains a test strip 80 from blood glucose test strip assembly 14 by removing end cap 46 therefrom to expose the test strip(s) 80 positioned therein. In at least one embodiment, cap 69 is then removed from the lancet end 37 of housing 12 and depth mechanism 70, such as a dial, is turned appropriately to adjust a desired depth of penetration for the lancet 68. If the penetration depth has already been adjusted, a user would not need to again perform the aforementioned step.

Lancet end 37 of housing 12 is then situated over the desired body part from which a blood sample will be taken. In an exemplary embodiment, button 62 is then pushed and released so that lancet 68 pierces the skin and causes a drop of blood to be expelled. Test strip 80 is inserted into test opening 18 of meter 10 either before or after lancet 68 pierces the skin, and the drop of blood is then deposited onto test strip 80. A drop of blood could also be obtained prior to insertion of test strip 80 into test opening 18 of meter 10. The test strip acceptance and reading area 54 of circuit board 50 then reads/processes the test strip 80 to obtain strip data and provides same to the processor 52. Memory 53 is provided within meter 10 and is operably coupled to processor 52 so that strip data from processor 52 may be stored within memory 53 as needed/desired. Memory 53 may also store programming (software) as necessary for use by processor 52 for the various functions and/or operating modes of various embodiments of meter 10. Data may be transmitted using data transfer mechanism 75 as shown in FIG. 5A, for example, which is operably coupled to circuit board 50, processor 52, memory 53, and/or blood glucose test strip acceptance and reading area 54. In at least one embodiment, data transfer mechanism 75 comprises a USB port, and in at least another embodiment, data transfer mechanism 75 comprises a wireless transfer device.

After the samples has been read, test strip 80 may be removed from test strip acceptance and reading area 54 and discarded. In at least one embodiment of meter 10, and to allow a user of meter 10 to safely discard test strips 80 that have come in contact with the user's blood, meter 10 comprises a slot 76, as shown in FIG. 4B, sized and shaped to receive used test strips 80. A user may then remove used test strips 80 from meter 10 in several ways, including inverting meter 10 to allow used test strips 80 to be removed, and/or opening one or more components of meter 10 (such as, for example, housing 12) to facilitate removal of used test strips 80.

Furthermore, and in at least one embodiment of a meter 10 of the present disclosure such as the embodiment shown in FIG. 2B, an absorbent pad 78 may be positioned upon housing 12, whereby a user can remove excess blood from his or her finger, for example, by wiping the finger on absorbent pad 78. In an exemplary embodiment, absorbent pad 78 may be positioned upon housing area 77 of housing 12, as shown in FIG. 2B. A user may the remove and replace absorbent pad 78 with a new absorbent pad 78 as desired.

Meter 10 may be operable using a portable power/energy source, such as a battery 73 as shown in FIG. 5, and may be held within housing 12 by way of a battery cover 74. Battery 10 may be removable and/or rechargeable in various embodiments of meters 10 of the present disclosure.

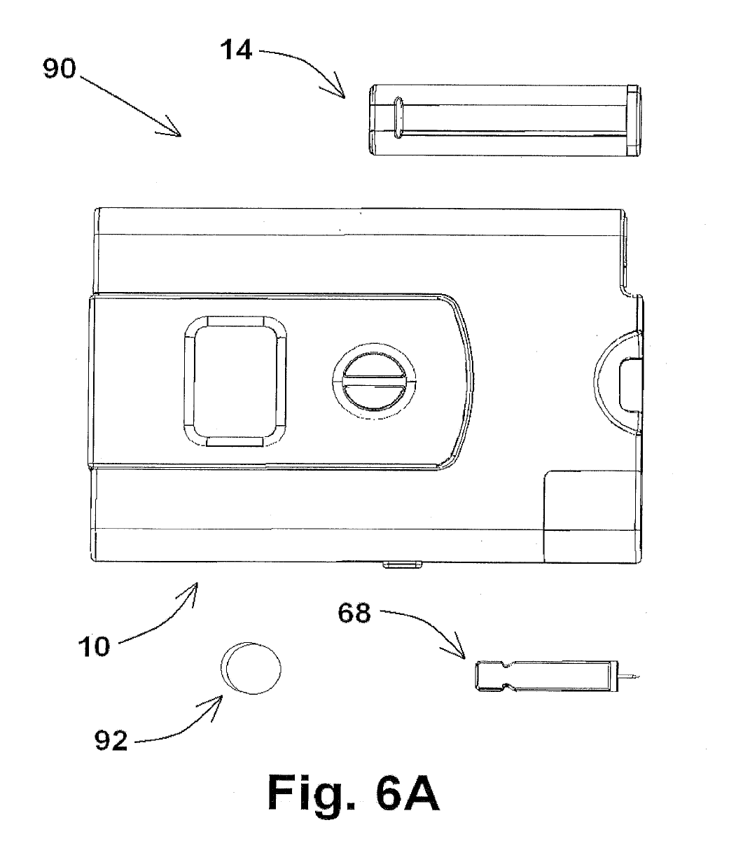

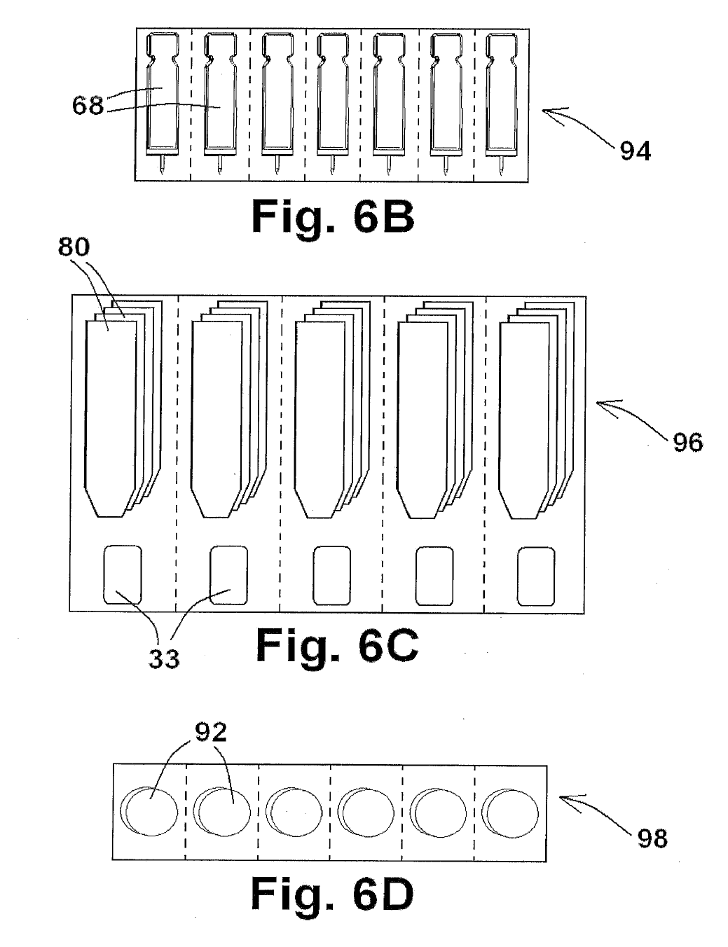

An exemplary kit 90 of the present disclosure is shown in FIG. 6A. As shown in FIG. 6A, kit 90 comprises an exemplary meter 10, a blood glucose test strip assembly 14, and a lancet 68. In at least one embodiment, kit 90 further comprises a tablet 92, which may be a glucose tablet or other tablet comprising a sugar, which itself may be housed within meter 10 and consumed as needed/desired.

In various embodiments of kits 90, said kits 90 may have their consumable portions replenished by way of various packages containing said components. For example, and as shown in FIG. 6B, a lancet packet 94 comprising lancets 68 may be used with an exemplary kit 90, whereby one or more packaged lancets 68 may be removed by way of, for example, perforations within lancet packet 94. Similarly, and as shown in FIG. 6C, a test strip packet 96 may comprises one or more test strips 80, and optionally one or more desiccants 33, and as shown in FIG. 6D, a tablet packet 98 may comprise one or more tablets 92.

In various embodiments of meters 10 of the present disclosure, meters 10 are capable of storing test data within memory 53, whereby said data is retrievable from memory 53 and displayed (or further processed and displayed) on display 20. For example, and in an exemplary embodiment of a meter 10 of the present disclosure, meter 10 is operable to store up to ninety-nine (99) tests in memory 53 to provide seven (7), fourteen (14) or thirty (30) day blood glucose level averages. In other embodiments, more or less data may be stored, and more or less calculations may be performed by components within meter 10. In various embodiments, time and date information may be provided by the meter 10, and meter 10 may automatically turn itself off after a predetermined period of nonuse. For example, buttons 24, 26, and/or or the insertion of test strip 80 may be used to turn meter 10 on, and buttons 24, 26 may be used to cycle through the various features/functions, and select the various meter options.

In various embodiments, and as referenced above, processor 52 (and/or another component of meter 10) may incorporate a wireless communications protocol that allows the wireless transmission of data to and/or from meter 10. The wireless communications protocol may also allow the reception of incoming wireless signals. In addition, one or more ports (such as data transfer mechanism 75), may be provided to allow meter 10 to be connected to an external device for the downloading and/or uploading of meter data, and/or to allow the uploading of meter programming if desired.

As referenced herein, various embodiments of meters 10 are provided and described. The scope of the present disclosure includes, for examples, meters 10 for use with testing blood glucose levels, but said meters 10 may be used to test various other chemical levels within a bodily fluid, and may be used with one or more other types of test strips to that a user may check for the presence and/or levels of a particular chemical within a bodily fluid.

While various embodiments of blood glucose meters and kits and methods for using the same have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

We claim:

1. A device, comprising:
a main housing sized and shaped to receive a lancet assembly and a test strip holder;
a circuit board positioned within the main housing, the circuit board capable of producing data indicative of a test strip fluid; and
a processor operably coupled to the circuit board, the processor capable of receiving and processing the data from the circuit board and displaying a processed result on a screen.

2. The device of claim 1, further comprising:
a lancet assembly positioned at least partially within the main housing, the lancet assembly comprising a lancet and a lancet mechanism.

3. The device of claim 2, wherein the lancet assembly is removable from the main housing.

4. The device of claim 2, wherein the lancet assembly comprises a lancet holder sized and shaped to removably engage a lancet.

5. The device of claim 2, wherein the lancet mechanism is operable to cause the lancet to at least partially protrude from the main housing.

6. The device of claim 2, wherein the lancet mechanism comprises a button, whereby depression of the button causes the lancet to at least partially protrude from the main housing.

7. The device of claim 6, wherein when the button is released, the lancet retracts back into the main housing.

8. The device of claim 2, wherein the lancet assembly further comprises a depth mechanism to adjust a penetration depth of the lancet.

9. The device of claim 8, wherein the depth mechanism comprises a dial so that the penetration depth of the lancet is a variable penetration depth.

10. The device of claim 8, wherein the depth mechanism comprises a body having a defined width, wherein when the body is positioned relative to the lancet assembly, the lancet is capable of protruding only a known distance beyond the body.

11. The device of claim 10, wherein the body comprises a plurality of interchangeable bodies, each of the plurality of interchangeable bodies having various defined widths.

12. The device of claim 2, further comprising:
a removable lancet assembly cap, the removable lancet assembly cap sized and shaped to removably enclose the lancet within the lancet assembly.

13. The device of claim 1, further comprising:
a test strip holder positioned within the main housing, the test strip holder sized and shaped to receive a plurality of test strips.

14. The device of claim 13, wherein the test strip holder is removable from the main housing.

15. The device of claim 13, wherein the main housing further comprises a housing coupling arrangement capable of receiving, retaining, and dispensing the test strip holder.

16. The device of claim 15, wherein the housing coupling arrangement comprises a slot sized and shaped to receive a flange of the test strip holder.

17. The device of claim 15, wherein the housing coupling arrangement comprises a protrusion sized and shaped to engage an indention of the test strip holder.

18. The device of claim 14, further comprising:
a first removable test strip holder cap, the first removable test strip holder cap sized and shaped to removably close a cavity defined within the test strip holder to enclose one or more optional test strips within the test strip holder.

19. The device of claim 18, further comprising a second removable test strip holder cap, the second removable test strip holder cap sized and shaped to removably close a cavity defined within the test strip holder to enclose one or more optional test strips within the test strip holder

20. The device of claim 14, further comprising:
a desiccant positioned within the test strip holder, the desiccant capable of reducing a local humidity level within the test strip holder.

21. The device of claim 1, further comprising:
a used test strip slot defined within the main housing, the used test strip slot sized and shaped to received one or more used test strips for retention within the main housing.

22. The device of claim 1, further comprising:
an absorbent pad removably coupled to the main housing, the absorbent pad capable of absorbing blood from a user.

23. The device of claim 1, wherein the circuit board comprises a test strip acceptance and reading area, the test strip acceptance and reading area capable of receiving at least part of a test strip and producing the data indicative of a test strip fluid from the test strip.

24. The device of claim 1, further comprising:
a display operably coupled to the processor, the display capable of displaying the processed result from the processor.

25. The device of claim 24, wherein the display comprises a liquid crystal display.

26. The device of claim 1, further comprising:
a user controller operably coupled to the processor, the user controller capable of selecting between two or more processor operations.

27. The device of claim 26, wherein the user controller comprises one or more buttons.

28. The device of claim 1, further comprising:
a memory device operably coupled to the processor, the memory device capable of receiving and storing data from the circuit board.

29. The device of claim 28, wherein the memory is further capable of receiving and storing software accessible by the processor for operating the device.

30. The device of claim 1, further comprising:
a power source operably coupled to the processor, the power source capable of supplying power to operate the device.

31. The device of claim 30, wherein the power source comprises a battery.

32. The device of claim 31, wherein the battery is rechargeable.

33. The device of claim 31, wherein the battery is removable from the device.

34. The device of claim 1, further comprising:
a data transfer mechanism operably coupled to the processor or a memory coupled thereto, the data transfer mechanism capable of transferring the data from the device to an external computer.

35. The device of claim 34, wherein the data transfer mechanism is further capable of transferring software to or from the device.

36. The device of claim 34, wherein the data transfer mechanism comprises a USB port.

37. The device of claim 34, wherein the data transfer mechanism comprises a wireless communications apparatus.

38. The device of claim 1, wherein the main housing is sized and shaped to fit within a garment pocket.

39. A device, comprising:
a main housing;
a test strip holder removably positioned at least partially within the main housing, the test strip holder capable of receiving at least one test strip;
a lancet assembly removably positioned at least partially within the main housing, the lancet assembly capable of receiving a lancet;
a circuit board positioned within the main housing, the circuit board comprising a test strip acceptance and reading area capable of receiving at least part of a test strip and producing the data indicative of a test strip fluid from the test strip;
a processor operably coupled to the circuit board, the processor capable of receiving and processing the data from the circuit board; and
a display operably coupled to the processor, the display capable of displaying the processed result from the processor.

40. A device, comprising:
a main housing sized and shaped to receive a lancet assembly and a test strip holder;
a lancet assembly positioned at least partially within the main housing, the lancet assembly comprising:
a lancet,
a lancet mechanism, the lancet mechanism operable to cause the lancet to at least partially protrude from the main housing, and
a depth mechanism to adjust a penetration depth of the lancet;
a test strip holder positioned within the main housing, the test strip holder sized and shaped to receive a plurality of test strips;
a used test strip slot defined within the main housing, the used test strip slot sized and shaped to received one or more used test strips for retention within the main housing;
an absorbent pad removably coupled to the main housing, the absorbent pad capable of absorbing blood from a user;
a circuit board positioned within the main housing, the circuit board comprising a test strip acceptance and reading area capable of receiving at least part of a test strip and producing the data indicative of a test strip fluid from the test strip;
a processor operably coupled to the circuit board, the processor capable of receiving and processing the data from the circuit board;
a memory device operably coupled to the processor, the memory device capable of receiving and storing data from the circuit board;
a display operably coupled to the processor, the display capable of displaying the processed result from the processor; and
a power source operably coupled to the processor, the power source capable of supplying power to operate the device.

41. A device for testing blood glucose levels, comprising:
a main housing;
a test strip holder removably positioned at least partially within the main housing, the test strip holder capable of receiving at least one glucose test strip;
a lancet assembly removably positioned at least partially within the main housing, the lancet assembly capable of receiving a lancet;
a circuit board positioned within the main housing, the circuit board capable of producing data indicative of blood from a used test strip;
a processor operably coupled to the circuit board, the processor capable of receiving and processing the data from the circuit board; and
a display operably coupled to the processor, the display capable of displaying a processed blood glucose level result indicative of the data on a screen.

42. A method of testing a blood glucose level, the method comprising the steps of:
removing a test strip from a test strip holder of a glucose testing device;
inserting at least part of the test strip into a test strip acceptance and reading area of the glucose testing device;
positioning the glucose testing device on or near a user's skin;
operating a lancet of the glucose testing device to penetrate the user's skin so that a quantity of blood exits a skin puncture caused by the lancet;
transferring at least part of the quantity of blood to the test strip; and
operating the glucose testing device to obtain data indicative of a blood glucose level from the quantity of blood.

43. The method of claim 42, further comprising the step of:
wiping excess blood from the quantity of blood onto an absorbent pad coupled to the glucose testing device.

44. The method of claim 42, further comprising the step of:
removing the test strip from the test strip acceptance and reading area; and
inserting the test strip into a used test strip slot defined within the glucose testing device to store the test strip within the glucose testing device.

45. A kit, comprising:
a device for testing a blood glucose level;
a blood glucose test strip assembly sized and shaped to be received within the device; and
a lancet sized and shaped to be received within a lancet assembly within the device.

46. The kit of claim 45, further comprising:
a tablet comprising a sugar, the tablet sized and shaped to fit within the device.

47. A kit, comprising:
a device for testing a blood glucose level;
a blood glucose test strip assembly sized and shaped to be received within the device;
a test strip packet comprising one or more test strips, the one or more test strips sized and shaped to fit within the blood glucose test strip assembly; and
a lancet packet comprising one or more lancets, the one or more lancets sized and shaped to be received within a lancet assembly within the device.

48. The kit of claim 47, wherein the test strip packet comprises a desiccant.

49. The kit of claim 47, further comprising:
a tablet packet comprising one or more tablets comprising a sugar, the one or more tablets sized and shaped to fit within the device.
